(19) United States
(12) Patent Application Publication
(10) Pub. No.: US 2007/0147181 A1
(43) Pub. Date: Jun. 28, 2007

(54) Time display

(76) Inventor: Thomas A. Piccirillo, Santa Monica, CA (US)

Correspondence Address: KLEINBERG & LERNER, LLP, 2049 CENTURY PARK EAST, SUITE 1080, LOS ANGELES, CA, 90067, US

(21) Appl. No.: 11/318,108

(22) Filed: Dec. 23, 2005

(51) Int. Cl. G04B 19/00

(52) U.S. Cl. 368/223

(57) ABSTRACT

A novel time display utilizes emphasized segments of geometric shapes to represent hours. Minutes and seconds are displayed in emphasized lozenges which are arranged around the shapes. Because the number of seconds in a minute is the same as the number of minutes in an hour, the displays can be adjacent each other. In a preferred embodiment, there are 24 segments allocated among 4 shapes assigning two shapes to a.m. and two to p.m. In other embodiments, only 12 segments are required which can be allocated to fewer geometric shapes. In a preferred embodiment, the emphasis is provided by illuminated LEDs.

### CROSS REFERENCE TO RELATED APPLICATIONS

N/A

### STATEMENT REGARDING FEDERALLY SPONSORED RESEARCH/DEVELOPMENT

N/A

### REFERENCE TO MICROFICHE APPENDIX

N/A

### BACKGROUND OF THE INVENTION

1. Field of the Invention

The present invention is related to the provision of a display of the time of day and more particularly, a new paradigm for the display of the time.

2. Description of the Related Art

Time has been an important concern of man and various methods have been developed for noting the passage of time and for displaying, in an easily recognizable format, the time of day. Among the earliest devices to mark the passage of time were sand glasses, which could only measure the passing of a predetermined interval. Sun dials could, when the sun was visible, display, in numeric form, the time of day by appropriately noting the movement of a shadow as the earth rotated, changing the relative position of the sun in the sky.

With the development of clocks and watches, one or more hands on a dial face could signal the passage of seconds, minutes, hours, days and even months. These displays relied upon rotating hands and marked numbered intervals on the watch face, the relative positions of which, at any instant, could be interpreted as displaying a time of day within a month.

More recently, electronic circuits have been employed to mark time and numeric displays have been generated which provided a digital read out of the time, rather than the analog readout of hands rotating against a stationary watch face. In fact, some time pieces have eliminated the numeric symbols and have relied solely upon the angular position of the hour and minute hands to signal the time of day.

Yet other time display schemes have been introduced but most are variations on the analog display of watches and clocks. What would be useful is a display that did not require numbers or moving parts.

### SUMMARY OF THE INVENTION

According to a preferred embodiment of the present invention, a time telling display includes a plurality of geometric shapes, each subdivided into segments for a 24 hour application. Each segment can represent an hour and the time is displayed by illuminating or highlighting either a number of segments corresponding to the hour of the day or a particular segment which is representative of that hour. For example, in the hour following midnight, no segments are accentuated.

In a preferred embodiment, four shapes are provided, each subdivided into six segments. The hours of 1-6 can then be represented by either the cumulative display of one through six segments, respectively, or, alternatively, only one segment need be accentuated at any time and the position of the accentuated segment relative to the others can represent the designated hour.

Lesser units of time are displayed through the use of two concentric rings, each with sixty equally spaced symbols. Minutes and seconds can be respectively associated with the symbols in the rings. A distinctive marking separates each group of five symbols so that the familiar notation of minutes and seconds in increments of five can be retained.

In these embodiments using four shapes with six segments each, one half of the hour representing shapes can signal a.m. and the other half can signal p.m. While the placement of shapes is arbitrary, it may be desirable to have shapes to the left of a central vertical line represent a.m. and have the shapes to the right of the line represent p.m. It is also possible to have the shapes above a horizontal line represent a.m. and the shapes below the line represent p.m.

In another alternative embodiment, the shapes may be concentric rings, each subdivided into segments. Preferably, the number of shapes is four and the number of segments in each is six. In some special purpose embodiments, one could have three shapes with eight segments which would be useful in applications wherein the day is divided into three shifts of eight hours each.

In these embodiments, a cumulative number of segments may be accentuated, either by illumination or, in the case of some LCD displays, darkening. Alternatively, only a single segment need be accentuated, the position of the segment representing the hour of the day

Accordingly, it is an object of the present invention to provide a non traditional time display using illuminated shapes to represent time. It is another object of invention to provide a time display that need not have moving elements. It is a further object of invention to provide a time display that employs a cumulative effect to signal a time.

It is yet a further object of the invention to display time by distinguishing only one of a set of time representing indices to display, respectively, hours, minutes and seconds. It is another object of invention to display a set of unique symbols, the cumulative emphasis of which represents a time value.

The novel features which are characteristic of the invention, both as to structure and method of operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF THE DRAWINGS

FIG. 1 is a plan view of a time display device according to the present invention;

FIG. 2 is a plan view of an alternate embodiment of a time display device according to the present invention;

FIG. 3 is a plan view of a portion of the embodiment of FIG. 2, showing the display of minutes and seconds;

FIG. 4 is a plan view of yet another embodiment of a time display device according to the present invention;

FIG. 5 is a plan view of another alternative embodiment of a time display device according to the present invention;

FIG. 6 is a plan view of a variation of the embodiment of FIG. 5; and

FIG. 7, including FIGS. 7A, 7B , 7C and 7D are plan views of variations of yet additional alternative embodiments of a time display device according to the present invention.

### DETAILED DESCRIPTION OF THE INVENTION

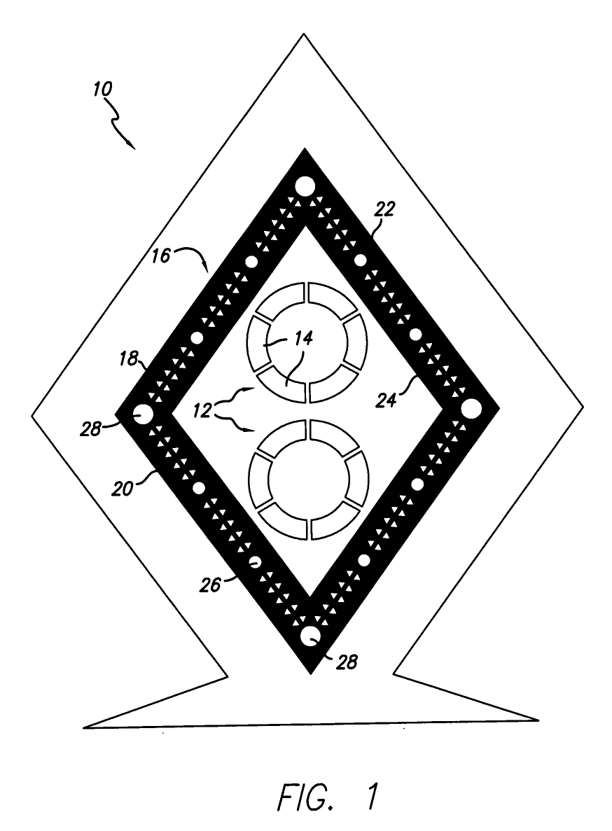

Turning first to FIG. 1, there is shown a preferred embodiment of a time display device 10 according to the present invention. In this embodiment, there are shown two toroidal shapes 12, each subdivided into six segments 14. Surrounding the toroidal shapes 12 is a rhombus or diamond 16. For the present embodiment, in each of the sides 18 of the rhombus 16 there are two rows of triangular display elements 20 with the bases of the triangles of the outer row 22 adjacent the bases of the inner row 24.

The triangular display elements 20 are arranged in groups of five, shown separated by small circular markers 26. Three groups are placed on each side 18 and these groups are separated by large circular markers 28. As a result, the usual conventions of marking quarter hour intervals and subdividing these intervals into five minute intervals are maintained.

The triangular display elements 20 are arranged in pairs of individual display units 30. The outer row may represent seconds while the inner row represents minutes. In other embodiments, the roles may be exchanged. The convention that there are 60 seconds to a minute and 60 minutes to the hour makes such an arrangement desirable and convenient.

In a preferred embodiment, the individual display units 30 are light emitting diodes (LED's) although they could, in other embodiments, be miniature incandescent lamps, liquid crystal display (LCD) devices, or even light emitting polymer (LEP) devices. Further, alternative illumination schemes are available to display the time of day. In one, preferred scheme, the display units are sequentially energized so that the time is represented by the position of the last to be illuminated display unit. In alternative schemes, the display units can all be initially energized with sequential de-energization so that the time is represented by position of the last to be de-energized display element.

In yet another, alternative illumination scheme, only a single display unit is energized at any one instant and the position of the energized display unit represents the time of day. Alternatively, all of the display units can be energized save the one that currently signals the displayed time. Each of these operating schemes can be mechanized using well known, existing techniques and will not be further elaborated upon. As a result, the time of day can be uniquely represented by selecting a particular toroidal segment 14 and particular display units 30 to indicate hours, minutes and seconds.

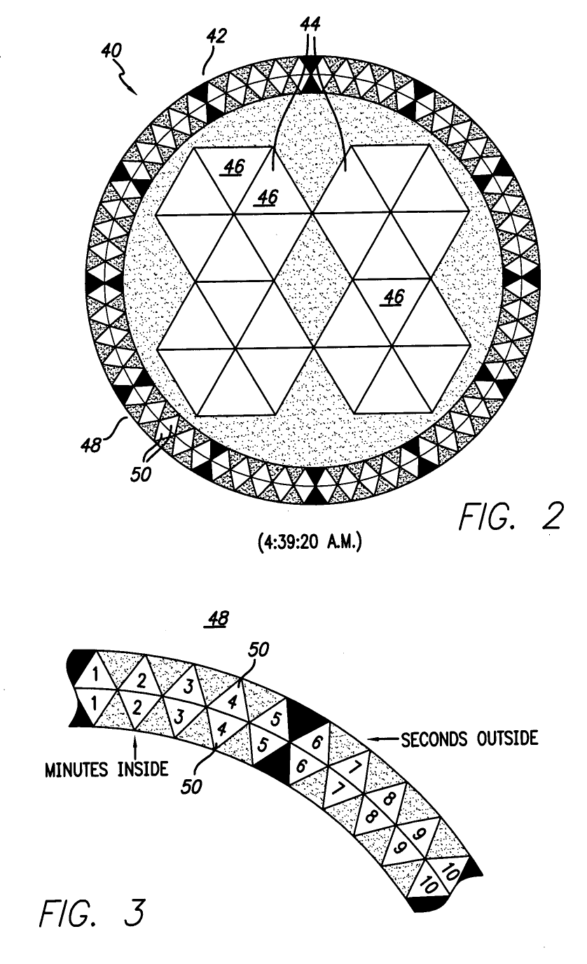

In FIG. 2, there is illustrated an alternative configuration of a time display device 40 of the present invention. In this embodiment, The display frame 42 is circular and the hour representing shapes are hexagons 44. As shown, four hexagons 44 are provided, each subdivided into six triangular segments 46. Surrounding the hexagons 44 are two concentric rings 48 of triangular display units 50.

Each segment 46 can be assigned a time value. For example, the hexagons 44 on the left can represent p.m. hours while the hexagons 44 on the right can represent a.m hours. The topmost segment 46 on the right hand hexagon 44 can arbitrarily be assigned the value of midnight (or in military time, 00). The next segment 46 in the clockwise direction would then represent 1 a.m. The rings 48 of triangular display units 50 can respectively represent minutes and seconds.

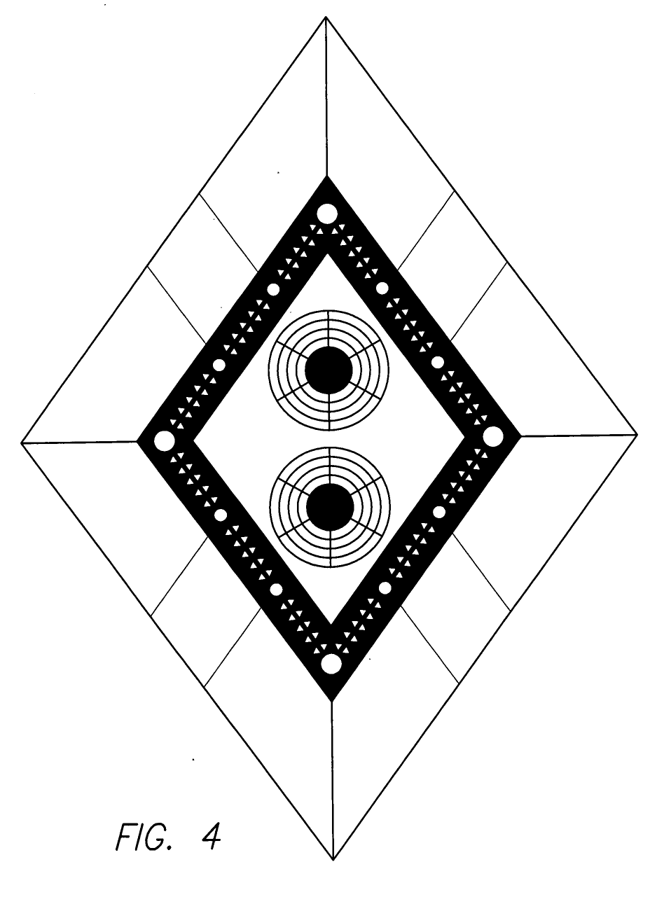

In FIG. 3, a sector of the concentric rings 48 shows, in greater detail, the placement of the triangular display units 50. As with the embodiment of FIG. 1, the display units 50 can be LEDs, LCDs or even incandescent or plasma displays for enabling a unique signal representing a time value in minutes and seconds.

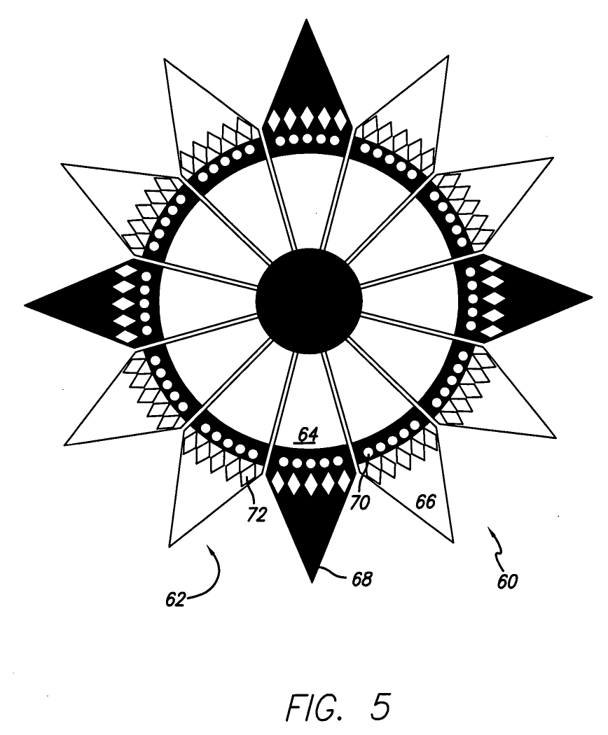

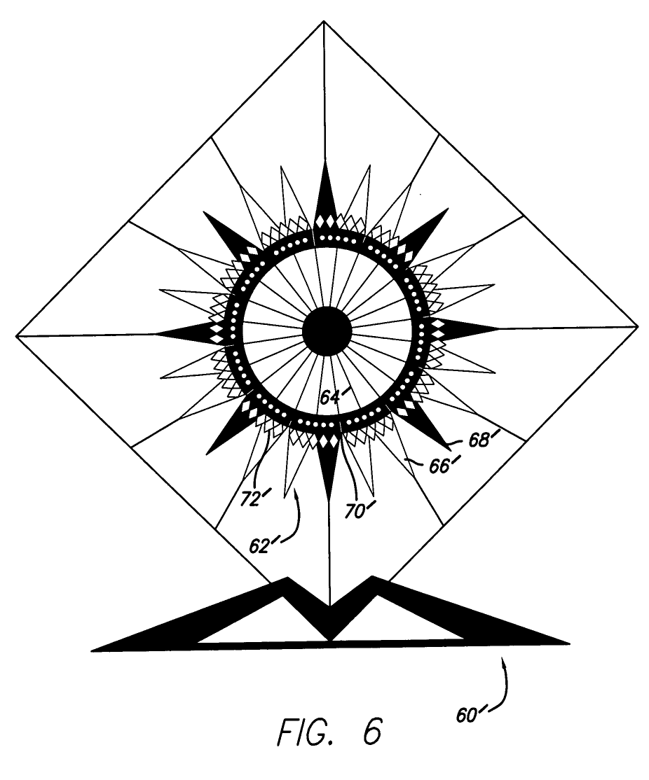

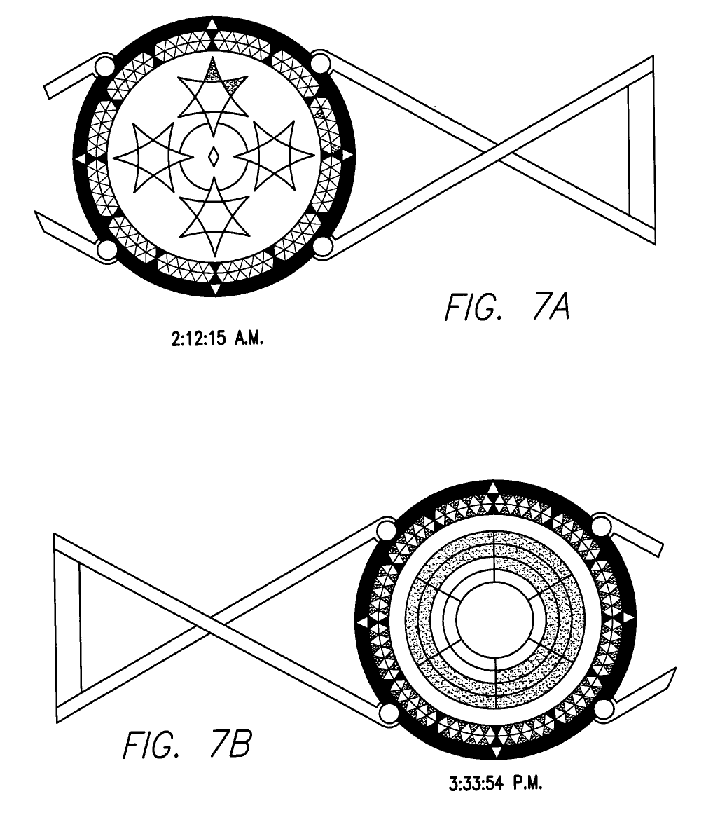

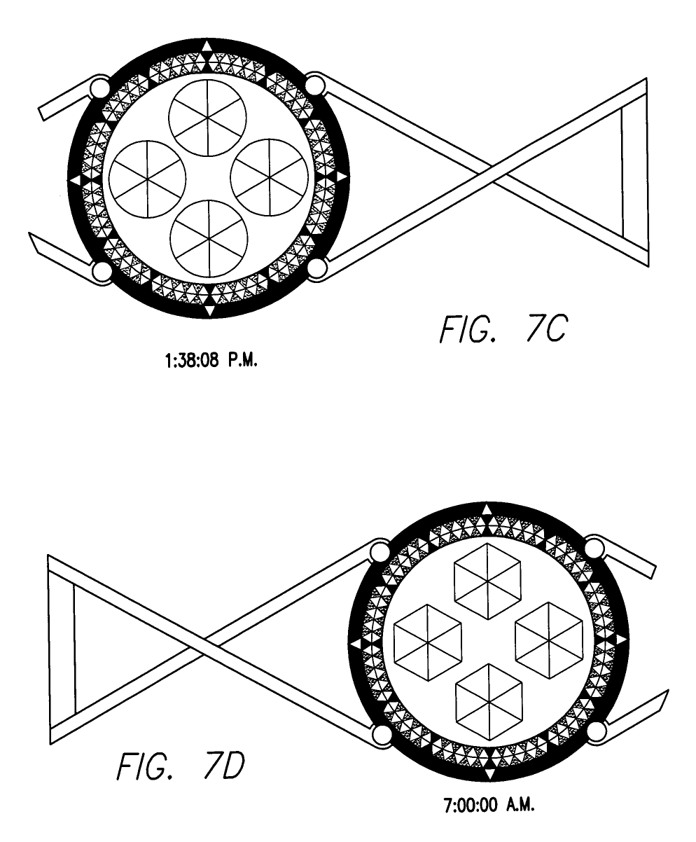

FIGS. 4-7, including FIGS. 7a through 7d, illustrate alternative embodiments of the present invention. These embodiments differ in the choice of geometric shapes employed to represent hours and in the configuration of display units that will correspond to minutes and seconds. It is noted that in the embodiments 60, 60′ shown in FIGS. 5 and 6, the hour representing elements 62, 62′ are truncated lozenges in a circular array. In the preferred embodiment of these alternatives, only the interior, truncated triangular segments 64, 64′ are emphasized while the outer triangular segments 66, 66′ are not emphasized. However, for reference, the segments 68, 68′, corresponding to the hours 3, 6, 9, etc. are distinguishable, as shown, by a color contrasting with the other segments. The second and minute representing display units 70, 70′, 72, 72′ are circular and lozenge or diamond shaped, respectively. This is a matter of design choice and the roles could be reversed with the circular shapes representing minutes and the lozenge shapes representing minutes. However, the principles of operation are consistent with the embodiment of FIG. 1.

In the embodiment of FIG. 7a, the display unit 80 uses four six pointed stars 82 to represent a 24 hour day. The second and minute representing display units, 84, 86 are similar to the units of FIGS. 5 and 6. In FIG. 7b, the hours are represented by a series of concentric circular segments similar to those of FIG. 4. In FIG. 7c, the chosen geometric shape is a circle, subdivided into six segments, and in FIG. 7d, the chosen geometric shape is a hexagon.

Other variations and modifications may occur to those experienced in the art, but it is believed that the concepts expressed herein represent an innovative method and apparatus to display the time of day. Accordingly, the invention should be limited only by the scope of the claims appended below.

What is claimed is:

1. A time display device comprising:
a. a first plurality of geometric figures, each subdivided into hour representing segments;
b. a second plurality of minute representing geometric shapes surrounding said first plurality:
c. a third plurality of second representing geometric shapes surrounding said first plurality; and
d highlighting means connected to said segments and said geometric shapes for selectively emphasizing shapes and segments to provide a unique representation of the time of day.

2. The time display of claim 1 in which the geometric figures of the first plurality are hexagons.

3. The time display of claim 1 in which the geometric figures of the first plurality are truncated lozenges.

4. The time display of claim 1 in which the geometric figures of the first plurality are segments of a circle.

5. The time display of claim 1 in which the geometric figures of the first plurality are six pointed stars.

6. The time display of claim 1 in which the geometric figures of the second plurality are lozenges.

7. The time display of claim 1 in which the geometric figures of the second plurality are triangles.

8. The time display of claim 1 in which the geometric figures of the second plurality are circles.

9. The time display of claim 1 in which the geometric figures of the third plurality are lozenges.

10. The time display of claim 1 in which the geometric figures of the third plurality are triangles.

11. The time display of claim 1 in which the geometric figures of the third plurality are circles.

12. A method of displaying time comprising the steps of:
a. illuminating a predetermined area of a geometric figure to represent an hour;
b. illuminating at least a predetermined one of a plurality of minute representing geometric figures; and
c. illuminating at least a predetermined one of a plurality of second representing geometric figures.

13. The method of claim 12, wherein said predetermined area is a single segment of a multisegmented geometric figure.

14. The method of claim 12, wherein said predetermined area includes all of the segments of a multisegmented geometric figure except for a selected segment.

15. The method of claim 12, wherein all but a selected one of said plurality of minute representing geometric figures are illuminated.

16. The method of claim 12, wherein all but a selected one of said plurality of second representing geometric figures are illuminated.
